(19) United States
(12) Patent Application Publication
(10) Pub. No.: US 2011/0023563 A1
(43) Pub. Date: Feb. 3, 2011

(54) Two-way opened padlock

(76) Inventor: Chien-Yung Huang, Banchiao City (TW)

Correspondence Address: PRO-TECHTOR INTERNATIONAL SERVICES, 20775 NORADA CT., SARATOGA, CA, 95070, US

(21) Appl. No.: 12/511,952

(22) Filed: Jul. 29, 2009

(51) Int. Cl. E05B 67/00

(52) U.S. Cl. 70/31

(57) ABSTRACT

A two-way opened padlock is a padlock having a housing and a shackle, a tumbler which can rotate relative to the housing and a block which can slide relative to the housing. The padlock can use a rotatable key to insert into a slot to rotate the tumbler to enable opening the lock and can also use a sliding key to deviate the block to enable opening the lock. Therefore, an effect that the lock can be opened in two ways is provided.

### BACKGROUND OF THE INVENTION

a) Field of the Invention

The present invention relates to a two-way opened padlock, and more particularly to a two-way opened padlock which can be opened or closed with a sliding key or a rotatable key.

b) Description of the Prior Art

A conventional padlock only uses a key or card to enable opening or closing the lock, and is not provided with a padlock to use a key and a card to enable opening or closing the lock at a same time. Hence, there is a need for improvement to the prior art.

### SUMMARY OF THE INVENTION

Accordingly, the primary object of the present invention to provide a two-way opened padlock, and more particularly to a padlock, which can use a rotatable key to insert into a slot of a tumbler to enable opening the lock, and can also use a sliding key to deviate a block to enable opening the lock, thereby providing an effect that the lock can be opened in two ways.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows an exploded view of the present invention.

FIG. 2-1 shows a rear sectional view of the present invention in an unlocking position.

FIG. 3 shows a rear sectional view of the present invention in a locking position.

FIG. 4 shows a rear sectional view of the present invention when opening a lock by a rotatable key.

FIG. 5 shows a rear sectional view of the present invention when opening a lock by a sliding key.

### DETAILED DESCRIPTION OF THE PREFERRED EMBODIMENTS

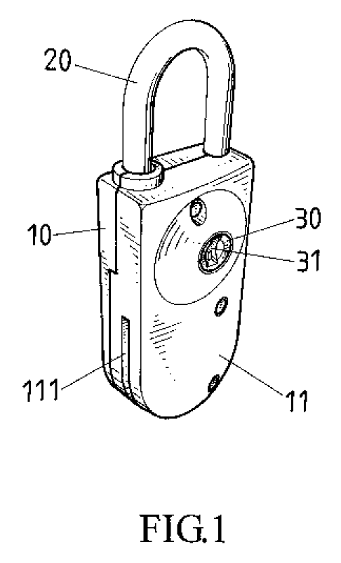

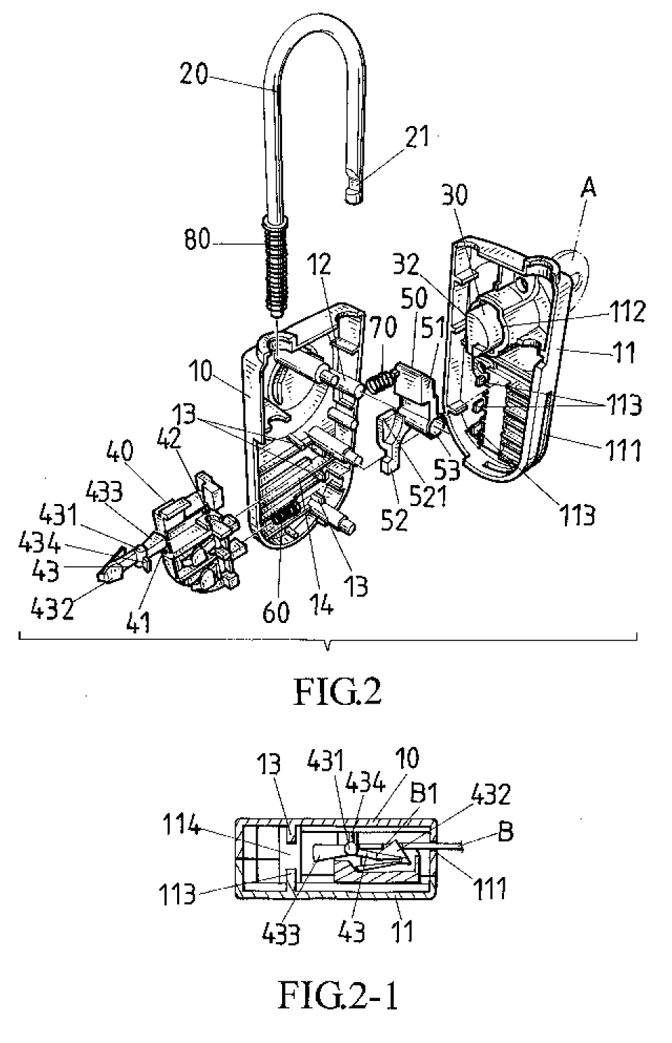

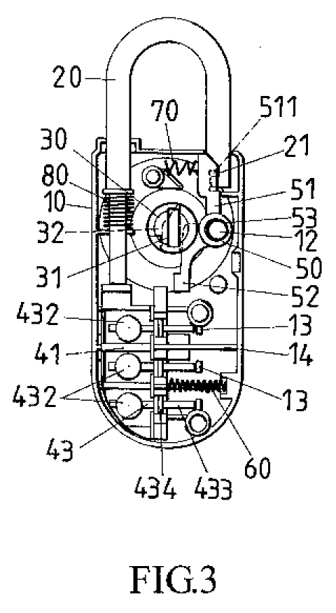

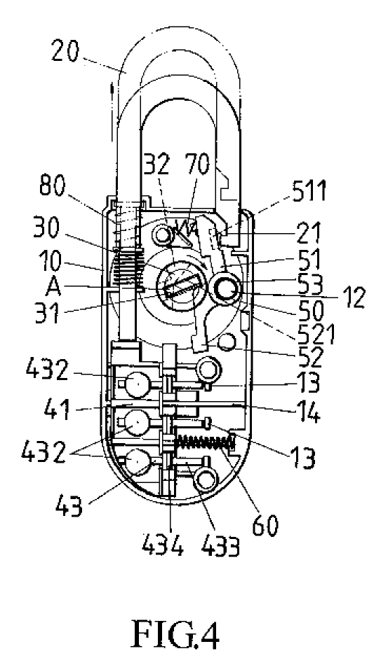

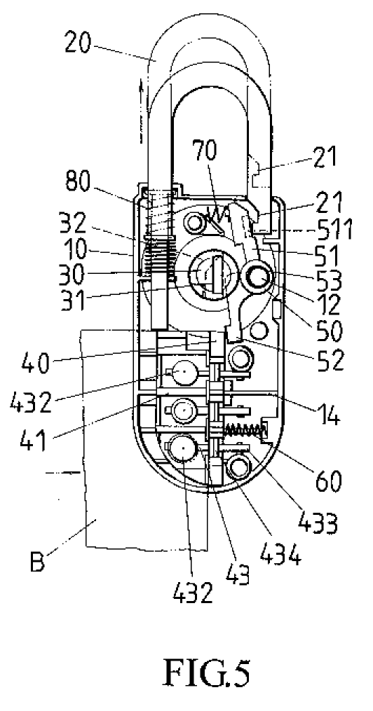

Referring to FIG. 1, the present invention comprises a housing 10 and a shackle 20 which can move relative to the housing 10. Referring to FIG. 2 and FIG. 3, an interior of the housing 10 is provided with a tumbler 30 which can rotate relative to the housing 10 and a block 40 which can slide relative to the housing 10. Referring to FIG. 4, a rotatable key A can be inserted into a slot 31 to rotate the tumbler 30, thereby enable opening the lock. Referring to FIG. 5, a sliding key (or card) B can deviate the block 40 to enable opening the lock and a side of a cover 11 of the housing 10 is provided with a slot 111 allowing the sliding key B to insert into and slide.

The interior of the housing 10 is provided with a stopper 50 which includes an upper and a lower arm 51, 52. A shaft hole 53 of the stopper 50 is sheathed on a shaft 12 of the housing 10. As shown in FIG. 5, when the sliding key B is inserted into the housing 10 to push the block 40, the lower arm 52 can be pushed by the block 40 (a spring 60 is squeezed) to rotate the stopper 50 and a spike 511 of the upper arm 51 can be separated with a hole 21 of the shackle 20 (the upper arm 51 squeezes another spring 70 at a same time), then the shackle 20 can be moved upward to open the lock (a spring 80 which is squeezed by the shackle 20 is extended).

Referring to FIG. 2, a through-hole 112 of the cover 11 can provide the tumbler 30 to be latched, and an interior of the cover 11 is formed corresponding to a shape of the housing 10, so as to form a proper inner space when the cover 11 is assembled with the housing 10. In addition, a proper position inside the cover 11 is provided with a baffle wall 113 corresponding to a height of a baffle block 13, so as to form a passage 114 that a fan-shaped unit 433 of a fixing block 43 can pass through at a correct angle (referring to FIG. 2-1). The irregular block 40 is located at a lower-left corner of the housing 10, and a chute 41 at a rear part is provided on a slide rod 14 at a bottom of the housing 10. An end of the block 40 is provided with at least one fixing slot 41, an interior of which can be pivoted by a shaft 431 of the fixing block 43. The fixing block 43 is a long and narrow element, an end of which is a cone-shaped unit 432 and the other end of which is the fan-shaped unit 433. The fixing block 43 on the block 40 is a block unit of a different oblique angle and when the sliding key B is inserted into the slot 111 of the housing 10, holes B1 (or not hole) of various sizes on the sliding key B are sheathed on the cone-shaped unit 432. When the sliding key B is a correct key to open the lock, the sliding key B can squeeze a push plate 434 above the fixing block 43 to push the block 40 to displace inward. As the fan-shaped unit 433 at a tail end of the fixing block 43 can be forwardly (without deviation) extended into the passage 114 that is formed between the baffle block 13 of the cover 11 and the baffle wall 113 (as shown in FIG. 2-1) and the block 40 can squeeze the spring 60; therefore, an upper-right corner of the block 40 will push the lower arm 52 of the stopper 50 to rotate, thereby opening the lock.

Referring to FIG. 4, the rotatable key A can be inserted into the slot 31 of the tumbler 30 to rotate the tumbler 30, and a semi-circular cam wheel 32 in an interior side of the tumbler 30 can push a bump 521 at a bottom end of the lower arm 52 of the stopper 50 to rotate the stopper 50. Then, the spike 511 of the upper arm 51 of the stopper 50 will be separated with the hole 21 of the shackle 20, so as to pull up the shackle 20 to open the lock.

As is apparent from the foregoing, the padlock of the present invention can be opened or closed with a sliding key or a rotatable card, thereby providing an effect that the lock can be opened in two ways.

What is claim is:

1. A padlock that is opened either by a rotatable key or by a sliding key, comprising a housing which is provided with a slot to let the sliding key to insert into and to slide to open the lock, the housing also containing a tumbler that is rotated by the rotatable key to open the lock.

2. The two-way opened padlock according to claim 1, wherein an interior of the housing is provided with a tumbler and a block, the rotatable key is inserted into the slot to rotate the tumbler to enable opening the lock, and the sliding key deviates the block to enable opening the lock.

3. The two-way opened padlock according to claim 1, wherein the housing is provided with a cover, an interior of which is provided with a slot allowing the sliding key to insert into and to slide.

4. The two-way opened padlock according to claim 1, wherein an interior of the housing is provided with a stopper which includes an upper and a lower arm, the upper arm being provided with a spike to hook with a hole of a shackle, the lower arm being pushed by a block to rotate the stopper that the stopper is separated with the shackle to open the lock, and the lower arm also being pushed by the tumbler to rotate the stopper that the stopper is separated with the shackle to open the lock.

5. The two-way opened padlock according to claim 1, wherein an interior of the block is provided with at least one block having a cone-shaped unit and a fan-shaped unit, such that when the sliding key is inserted into the slot of the housing and squeezes the block to displace inward, the stopper is pushed to move, thereby opening the lock.
